(19) United States
(12) Patent Application Publication
(10) Pub. No.: US 2021/0176920 A1
(43) Pub. Date: Jun. 17, 2021

(54) Bale Unroller Apparatus

(71) Applicant: Kyle Duckworth, Moatsville, WV (US)

(72) Inventor: Kyle Duckworth, Moatsville, WV (US)

(21) Appl. No.: 16/710,727

(22) Filed: Dec. 11, 2019

(51) Int. Cl. A01D 87/12

(52) U.S. Cl. CPC A01D 87/127; A01D 2087/128

(57) ABSTRACT

A bale unroller apparatus for distributing hay includes a frame configured to be coupled to a hitch of a tractor. A motor is coupled to the frame and rotates a driveshaft. A bale plate is coupled to the driveshaft and at least one bale spear is coupled to the bale plate. The bale spears are configured to support a hay bale. An extension arm is coupled to the frame and a rake is coupled to the extension arm. The rake has a plurality of tines extending towards the bale spears. As the motor rotates the bale plate the hay bale unrolls while the rake breaks apart the hay.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to livestock feeding devices and more particularly pertains to a new livestock feeding device for distributing hay.

### (2) Description of Related Art Including Information Disclosed Under 37 CFR 1.97 and 1.98

The prior art relates to livestock feeding devices. If livestock are fed in a concentrated area fields can easily be damaged to a point that grass will not regrow the following year. Hay bales must be unrolled and distributed to feed many cows simultaneously while preventing field damage. Existing bale unrollers typically secure the ball along its axis parallel to the axles of the tractor only distribute the hay as the tractor moves. These device and others often unroll the bale without breaking apart the hay, minimizing the distribution achieved.

### BRIEF SUMMARY OF THE INVENTION

An embodiment of the disclosure meets the needs presented above by generally comprising a frame configured to be coupled to a hitch of a tractor. A motor is coupled to the frame and rotates a driveshaft. A bale plate is coupled to the driveshaft and at least one bale spear is coupled to the bale plate. The bale spears are configured to support a hay bale. An extension arm is coupled to the frame and a rake is coupled to the extension arm. The rake has a plurality of tines extending towards the bale spears.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a bale unroller apparatus according to an embodiment of the disclosure.

FIG. 2 is a rear elevation view of an embodiment of the disclosure.

FIG. 3 is a side elevation view of an embodiment of the disclosure.

FIG. 4 is a front elevation view of an embodiment of the disclosure.

FIG. 5 is a top plan view of an embodiment of the disclosure.

FIG. 6 is an in-use view of an embodiment of the disclosure.

### DETAILED DESCRIPTION OF THE INVENTION

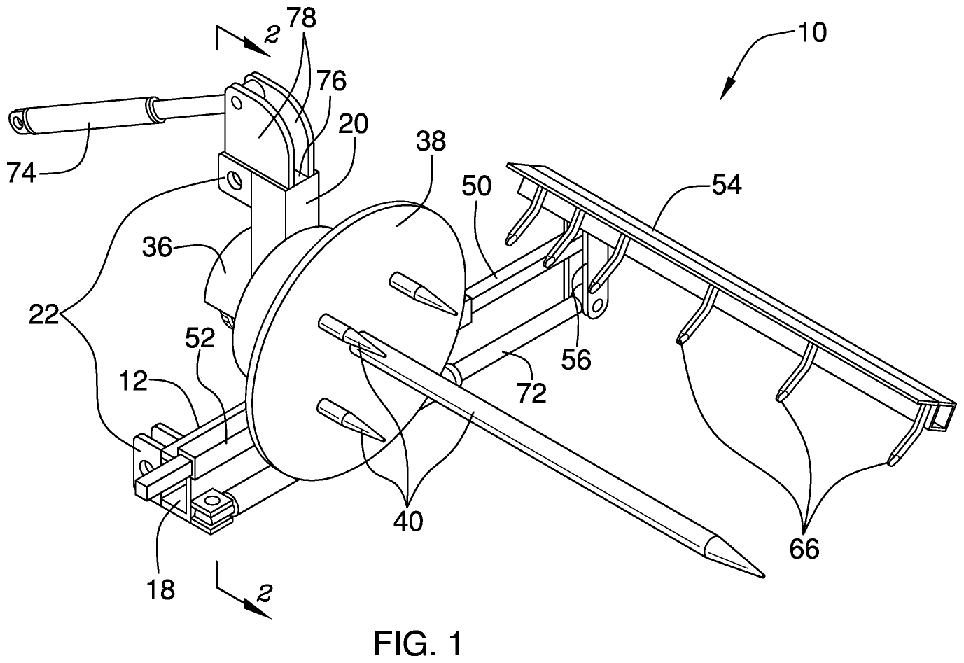

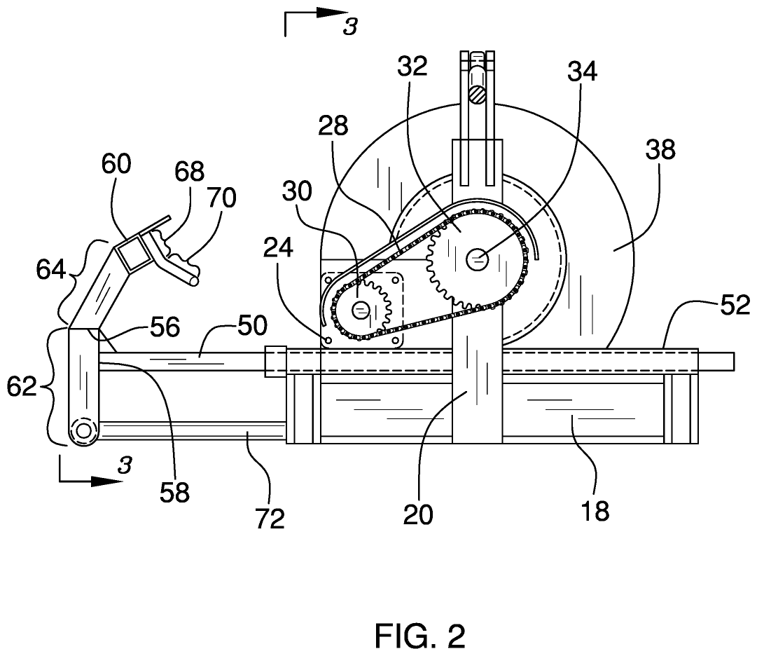

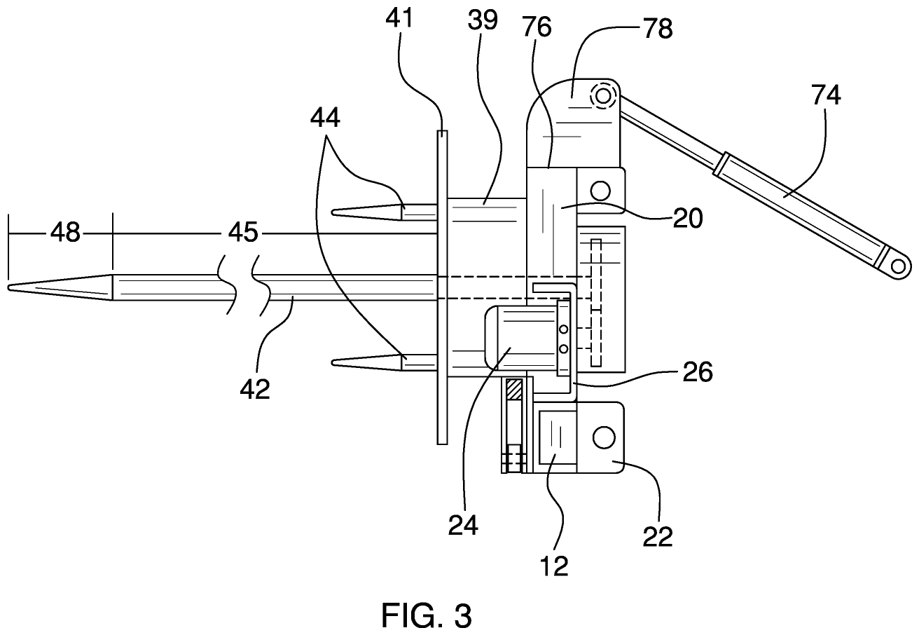

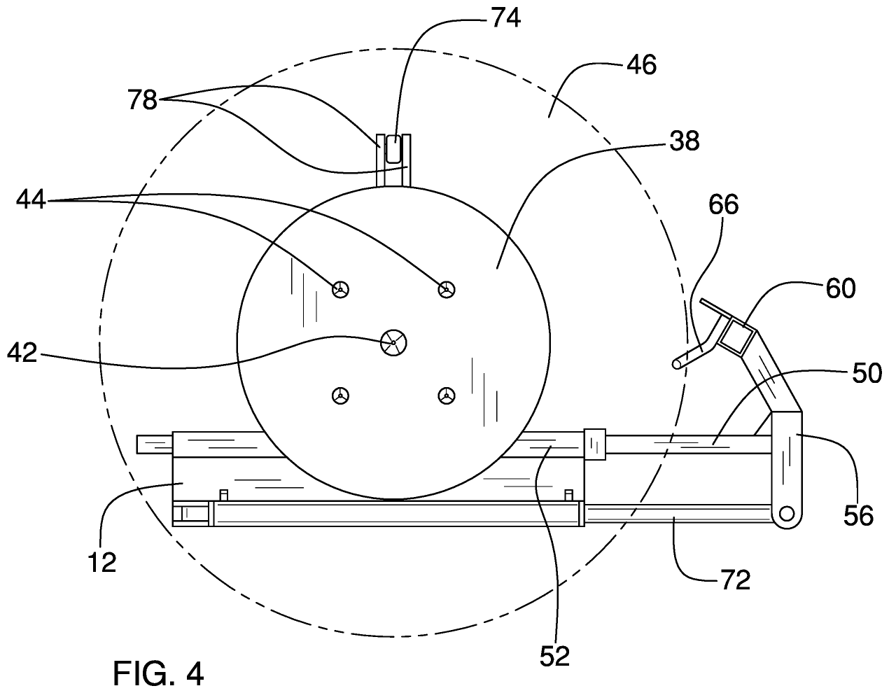

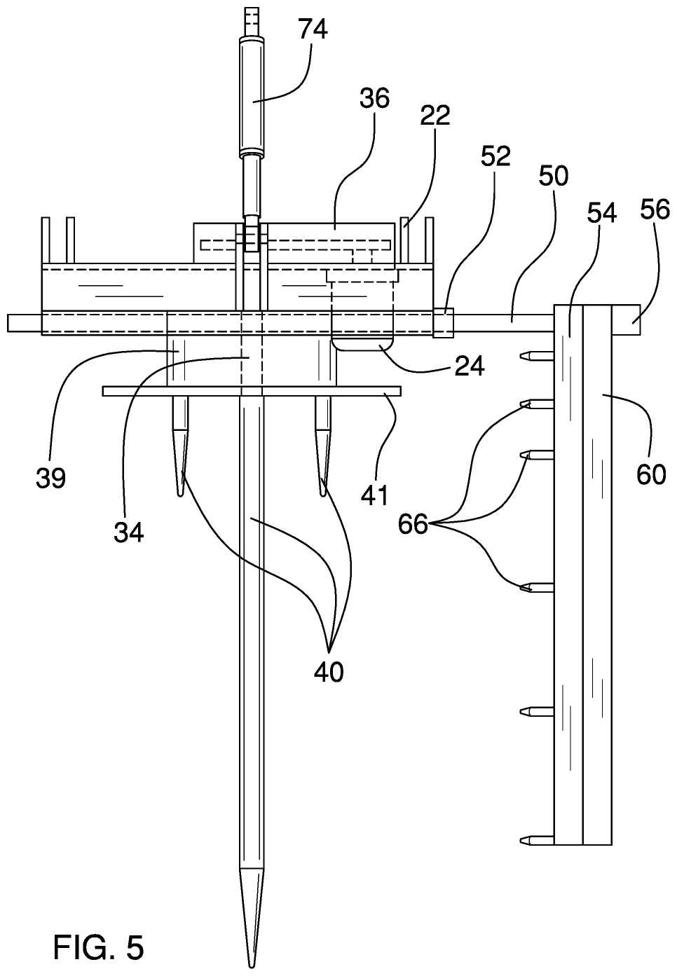

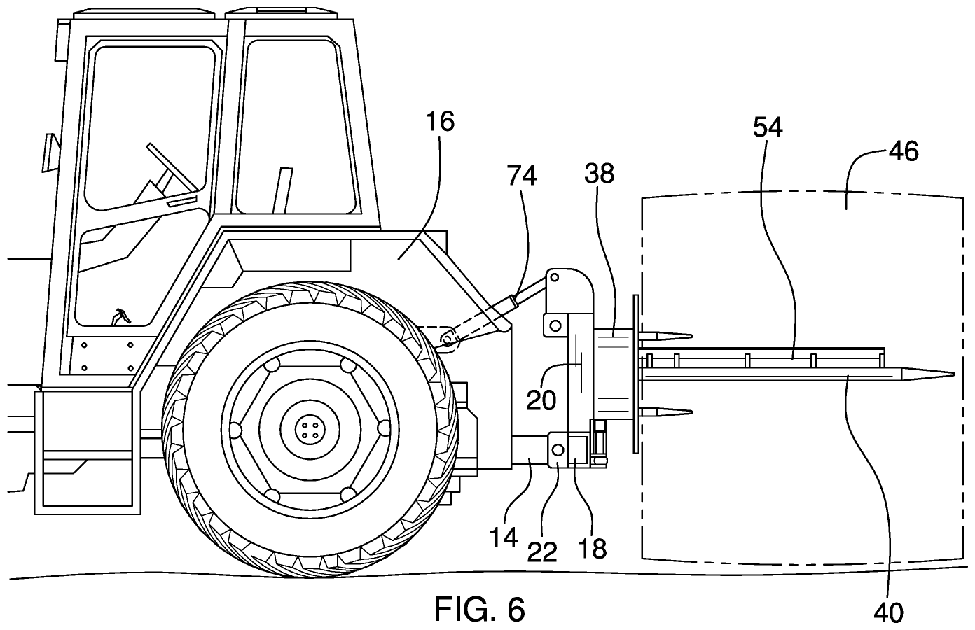

With reference now to the drawings, and in particular to FIGS. 1 through 6 thereof, a new livestock feeding device embodying the principles and concepts of an embodiment of the disclosure and generally designated by the reference numeral 10 will be described.

As best illustrated in FIGS. 1 through 6, the bale unroller apparatus 10 generally comprises a frame 12 configured to be coupled to a hitch 14 of a tractor 16. The frame 12 may have a horizontal base support portion 18 and a center support portion 20 perpendicularly extending up from the base support portion 18. A plurality of mounting brackets 22 may be coupled to the frame 12 and configured to pivotably attach to the tractor 16.

A motor 24 is coupled to the frame 12. The motor 24 may have a motor plate 26 coupled to the horizontal base support portion 18 and a chain 28 extending from a motor gear 30 to a drive gear 32 coupled to a driveshaft 34. The drive gear 32 is coupled to the center support portion 20 and the driveshaft 34 extends perpendicularly through the center support portion 20. A chain guard 36 may be coupled to the motor plate 26 and the frame 12 to protect the chain 28 and to prevent injury. The motor 24 may be independently powered or may be configured to operate with the hydraulics of the tractor 16.

A bale plate 38 is coupled to the driveshaft 34 and is rotated by the motor 24. The base plate 38 may comprise a cylindrical hub portion 39 and a circular plate portion 41 to extend the size of the base plate 38 without creating unnecessary weight. At least one bale spear 40 is coupled to the bale plate 38. The bale spears 40 may comprise a central spear 42 and a plurality of secondary spears 44 configured to support a hay bale 46. The secondary spears 44 are shorter than the central spear 42 and may be four secondary spears 44 evenly spaced around the central spear 42. Each bale spear 40 has a shaft portion 45 and a tapered tip portion 48. A length of the tip portion 48 may be equal to 20% of an overall length of the bale spear 40. The overall length of the central spear 42 may be 60″ to best support the hay bale 46.

An extension arm 50 is coupled to the frame 12. The extension arm 50 may be slidably coupled within a sleeve 52 of the frame coupled along the base support portion 18. The extension arm 50 thus moves within the sleeve 52 along an axis perpendicular to the bale spears 40. A rake 54 is coupled to the extension arm 50. The rake 54 may have a support arm 56 coupled to an outer end 58 of the extension arm 50 and a rake arm 60 perpendicularly extending from the support arm 56. The support arm 56 may have a vertical lower portion 62 and an angled upper portion 64. The sleeve 52 and the extension arm 50 may each by square to prevent rotation from the cantilevered rake arm 60. The rake 54 has a plurality of tines 66 extending towards the bale spears 40. Each tine 66 may have an attachment portion 68 coupled to the rake arm 60 and a finger portion 70 extending towards the bale spears 40.

An extension cylinder 72 is coupled to the frame 12 and the vertical lower portion 62 of the support arm 56 of the rake. The extension cylinder 72 moves the rake 54 towards and away from the bale spears 40 to engage the tines 66 with the hay bale 46 as desired. A tilt cylinder 74 may be pivotably coupled to a top end 76 of the center support portion of the frame. The top end 76 may have a pair of ears 78 to attach to each side of the tilt cylinder 74. The tilt cylinder 74 is configured to attach to the tractor 16 and to control an angle of the apparatus 10 relative the ground. The extension cylinder 72 and the tilt cylinder 74 may be powered by the hydraulics of the tractor 16.

In use, the mounting brackets 22 and the tilt cylinder 74 are attached to the tractor 16. The tractor 16 is driven to engage the bale spears 40 into the hay bale 46 with the central spear 42 aligned along a central axis of the hay bale 46. The motor 24 is then activated to unwind the hay bale 46 and the extension cylinder 72 is activated to engage or disengage the rake 54 with the hay bale 46 to break apart the hay bale 46 with the tines 66.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A bale unroller apparatus comprising:
a frame configured to be coupled to a hitch of a tractor;
a motor coupled to the frame, the motor rotating a driveshaft;
a bale plate coupled to the driveshaft;
at least one bale spear coupled to the bale plate, the bale spears being configured to support a hay bale;
an extension arm coupled to the frame, the extension arm being slidably coupled within a sleeve of the frame and moving along an axis perpendicular to the bale spear;
a rake coupled to the extension arm, the rake having a plurality of tines extending towards the bale spears; and
an extension cylinder coupled to the frame and a support arm of the rake, the extension cylinder moving the rake towards and away from the bale spear.

2. (canceled)

3. (canceled)

4. The bale unroller apparatus of claim 1 further comprising a tilt cylinder pivotably coupled to a top end of a center support portion of the frame, the tilt cylinder being configured to attach to the tractor and to control an angle of the apparatus relative the ground.

5. The bale unroller apparatus of claim 1 further comprising the at least one bale spear comprising a central spear and a plurality of secondary spears, the secondary spears being shorter than the central spear.

6. The bale unroller apparatus of claim 5 further comprising each bale spear having a shaft portion and a tapered tip portion.

7. The bale unroller apparatus of claim 6 further comprising a length of the tip portion being equal to 20% of an overall length of the bale spear.

8. The bale unroller apparatus of claim 5 further comprising the plurality of secondary spears being four secondary spears evenly spaced around the central spear.

9. The bale unroller apparatus of claim 1 further comprising the motor having a motor plate coupled to a horizontal base support portion of the frame and a chain extending from a motor gear to a drive gear coupled to the driveshaft.

10. A bale unroller apparatus comprising:
a frame configured to be coupled to a hitch of a tractor;
a motor coupled to the frame, the motor having a motor plate coupled to a horizontal base support portion of the frame and a chain extending from a motor gear to a drive gear coupled to a driveshaft;
a bale plate coupled to the driveshaft;
at least one bale spear coupled to the bale plate, the bale spears comprising a central spear and a plurality of secondary spears configured to support a hay bale, the secondary spears being shorter than the central spear, each bale spear having a shaft portion and a tapered tip portion;
an extension arm coupled to the frame, the extension arm being slidably coupled within a sleeve of the frame and moving along an axis perpendicular to the bale spear;
a rake coupled to the extension arm, the rake having a plurality of tines extending towards the bale spears;
an extension cylinder coupled to the frame and a support arm of the rake, the extension cylinder moving the rake towards and away from the bale spear; and
a tilt cylinder pivotably coupled to a top end of a center support portion of the frame, the tilt cylinder being configured to attach to the tractor and to control an angle of the apparatus relative the ground.

11. The bale unroller apparatus of claim 10 further comprising a length of the tip portion being equal to 20% of an overall length of the bale spear.

12. The bale unroller apparatus of claim 10 further comprising the plurality of secondary spears being four secondary spears evenly spaced around the central spear.
